(19) United States
(12) Patent Application Publication
(10) Pub. No.: US 2006/0174491 A1
(43) Pub. Date: Aug. 10, 2006

(54) Skin removing implement

(76) Inventors: Paul M. Anderson, Lincroft, NJ (US); Lisa F. Baumgarten, New York, NY (US); Antonette Bivona, Bayside, NY (US); John D. Butcher, Scotch Plains, NJ (US); Ingrid Yung-I Chen, New York, NY (US); Emily M. Cohen, New York, NY (US); Heath A. Doty, St. Louis, MO (US); Jeffrey F. Feng, St. Louis, MO (US); Stacey Leigh Grabiner, Westfield, NJ (US); David D. Kusch, St. Louis, MO (US); Jayne H. Lynch, St.Louis, MO (US); Bryce G. Rutter, St. Louis, MO (US); Heather S. Sopczynski, New York, NY (US)

Correspondence Address: Julie Blackburn;Revlon Consumer Products Corporation, Law Department, 237 Park Avenue, New York, NY, 10017, US

(21) Appl. No.: 11/333,062

(22) Filed: Jan. 17, 2006

Related U.S. Application Data
(60) Provisional application No. 60/651,741, filed on Feb. 10, 2005.

(51) Int. Cl. B26B 3/00

(52) U.S. Cl. 30/169

(57) ABSTRACT

An implement for removing skin comprised of a handle in the form of a tab with generally curved edges and a skin scraping surface being flat with generally curved edges wherein the handle is in a first plane and the skin scraping surface in a second plane and the first plane is perpendicular to the second plane, and a method for removing undesired skin from skin surfaces using the implement.

### RELATED APPLICATIONS

This application claims priority from U.S. provisional patent application Ser. No. 60/651,741, filed Feb. 10, 2005.

### TECHNICAL FIELD

The invention is in the field of implements or devices for removing or abrading skin from feet, elbows, or other areas.

### BACKGROUND OF THE INVENTION

It is desirable to remove rough, dead skin for a variety of reasons. For example, in the standard salon pedicure the technician will scrape rough or dead skin from the feet with a credo blade. The typical credo blade has a handle with attached head. The head has a razor blade fitted into it at such an angle that when the head is scraped across the bottom of the foot the blade will shave excess skin off the sole of the foot. There are a variety of disadvantages with credo blades. The handle tends to break easily. Because of the length of the handle, it is sometimes difficult to control the pressure with which the blade is scraped on the skin, causing either excess skin or not enough skin to be removed. In addition, because the blade is somewhat exposed it is possible for the user to more easily cut herself, or the razor blade to break more readily.

Accordingly, there is a need for a skin removing implement or device that can be used for pedicures and other beauty procedures where removal of rough, dead skin is desirable.

It is an object of the invention to provide a skin shaving or removal tool that is capable of removing skin from areas such as the soles of the feet, the elbows, and the like.

It is a further object of the invention to provide a skin removal implement that has an ergonomic handle that is easily gripped and manipulated by the user.

It is a further object of the invention to provide a skin removal implement that has a “guitar pick” handle affixed to a cartridge containing a razor blade for use in removing excess skin.

It is a further object of the invention to provide a skin removal implement that has a blade that can be quickly and easily removed and replaced with a clean, sharp blade.

### BRIEF DESCRIPTION OF THE DRAWINGS

FIG. 1 is a perspective view of the implement of the invention showing the “guitar pick” handle and scraping surface.

FIG. 2 is a ride side elevational view of the implement of the invention showing the bottom face of the scraping surface having the blade embedded therein.

FIG. 3 is a ride side view of the implement.

FIG. 4 is a front plan view of the implement.

FIG. 5 is a back plan view of the implement.

FIG. 6 is a bottom plan view of the implement showing the scraping surface.

FIG. 7 is a top plan view of the implement from the handle side.

### DETAILED DESCRIPTION

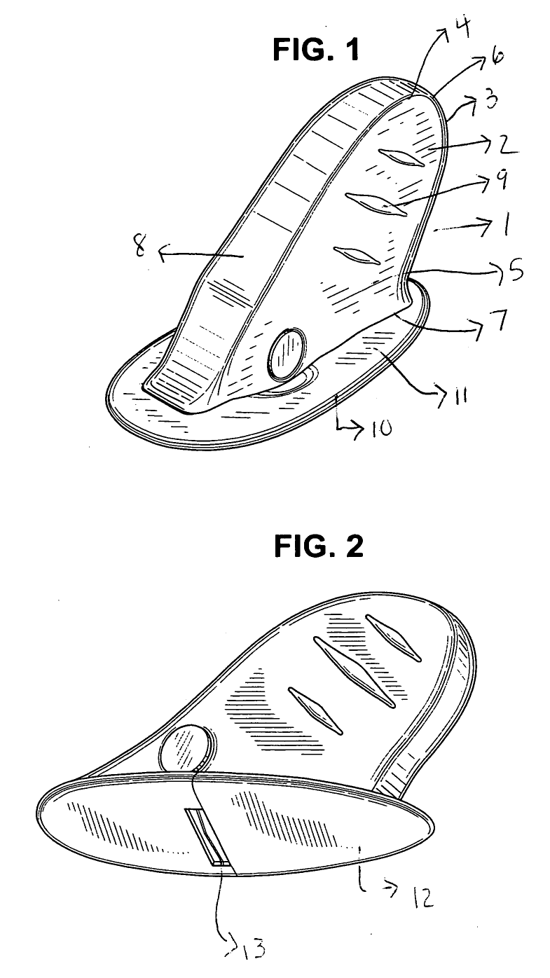

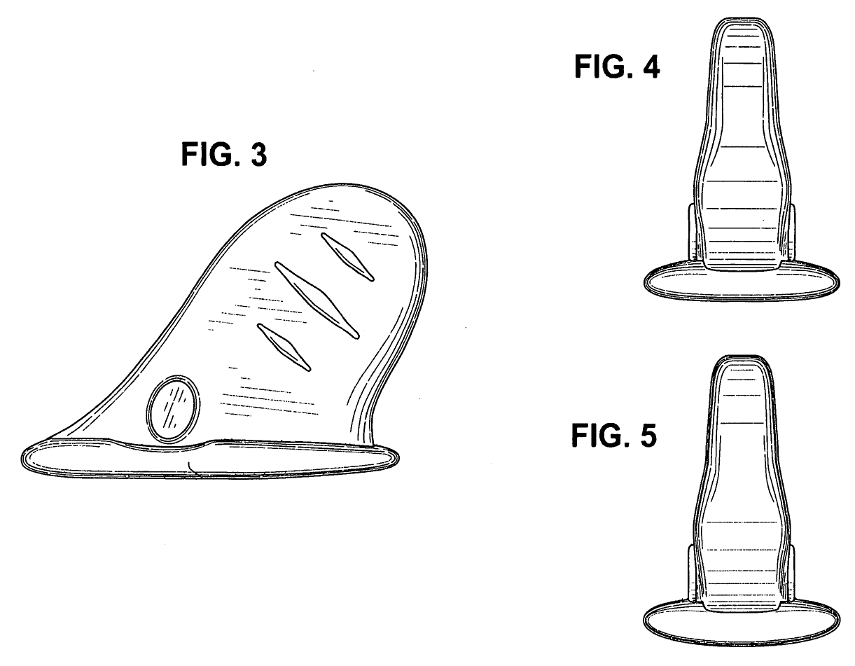

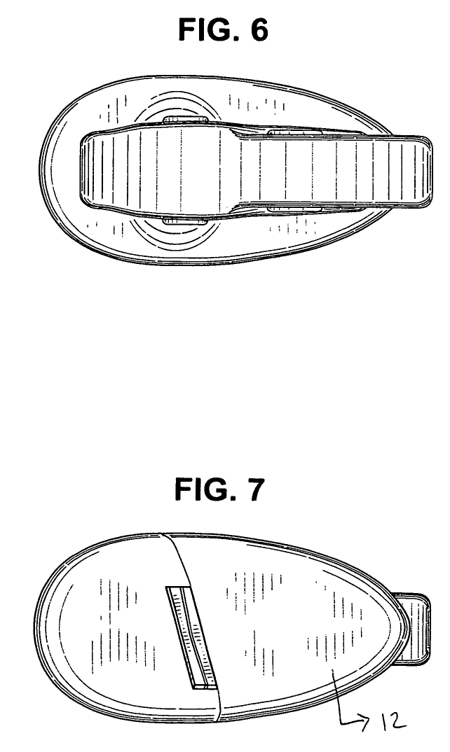

FIG. 1 illustrates the skin scraping implement 1 of the invention. It contains a handle 2 in the form of a tab 3 with generally curved edges 4. Preferably tab 3 has sides 5 having perimeter where the outer portion of tab 3 forms a loop 6 and the inner portion of tab 3 forms a straight edge 7. The tab 3 has a wall 8 between sides 5, which separates sides 5 and lies in a plane perpendicular to sides 5. Sides 5 may have cut-outs or protrusions 9 to further facilitate gripping by the user.

The handle 2 is in a first plane and affixed to scraping surface 10. Scraping surface 10 is in a second plane with first and second planes being perpendicular to each other. Scraping surface 10 has an upper surface 11 attached to handle 2 and a lower surface 12. Embedded within lower surface 12 is a razor blade 13 that extrudes from lower surface 12 to a degree sufficient so that it will shave dead or rough skin from skin surfaces when the lower surface 12 is scraped across such surfaces.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims.

We claim:

1. An implement for removing skin comprised of a handle in the form of a tab with generally curved edges and a skin scraping surface being flat with generally curved edges wherein the handle is in a first plane and the skin scraping surface in a second plane and the first plane is perpendicular to the second plane.

2. The implement of claim 1 wherein the skin removed is on the soles of the feet or the elbows.

3. The implement of claim 1 wherein the tab has generally curved edges.

4. The implement of claim 1 wherein the tab has sides.

5. The implement of claim 4 wherein the sides of the tab have a perimeter with an outer portion and wherein the outer portion of the tab forms a loop.

6. The implement of claim 5 wherein the sides of the tab have an inner portion.

7. The implement of claim 6 wherein the inner portion forms a straight edge.

8. The implement of claim 4 wherein the tab has a wall between sides.

9. The implement of claim 8 wherein the wall separates sides and lies in a plane perpendicular to sides.

10. The implement of claim 9 wherein the sides have cut outs or protrusions to facilitate gripping.

11. The implement of claim 1 wherein the skin scraping surface has an upper surface and a lower surface.

12. The implement of claim 11 wherein the upper surface is attached to a handle.

13. The implement of claim 11 wherein lower surface contains an embedded razor blade that extrudes from lower surface to a degree sufficient to shave dead or rough skin from the skin surface when lower surface is scraped across skin surface.

14. The implement of claim 1 wherein tab has protrusions to facilitate gripping by the user.

15. The implement of claim 1 wherein the tab has an outer portion forming a loop and an inner portion forming a straight edge and straight edge is attached to the scraping surface.

16. The implement of claim 1 wherein the tab has two sides and a wall in between the sides which is in a plane perpendicular to the sides.

17. A method for removing undesired skin from skin surfaces comprising abrading the skin from the surface with an implement comprised of a handle in the form of a tab with generally curved edges and a skin scraping surface being flat with generally curved edges wherein the handle is in a first plane and the skin scraping surface in a second plane and the first plane is perpendicular to the second plane.

18. The method of claim 17 wherein the skin is from the soles of the feet or elbows.

19. The method of claim 17 wherein the undesired skin is removed from the skin surface by scraping the skin scraping surface against the undesired skin.

20. The method of claim 17 wherein the tab has protrusions to facilitate gripping by the user.
